(19) United States
(12) Patent Application Publication
(10) Pub. No.: US 2009/0194562 A1
(43) Pub. Date: Aug. 6, 2009

(54) METERING APPARATUS FOR FLOWABLE COMPOSITIONS

(76) Inventors: Arndt Kessler, Monheim-Baumberg (DE); Arno Düffels, Düsseldorf (DE); Christian Nitsch, Düsseldorf (DE); Maren Jekel, Willich (DE); Johannes Zipfel, Hilden (DE); Hans-Georg Mühlhausen, Düsseldorf (DE); Frank Pessel, Düsseldorf (DE); Ralph Butter-Jentsch, Langenfeld (DE); Karl-Heinz Hohenadel, Langenfeld (DE); Matthias Lüken, Düsseldorf (DE)

Correspondence Address: CONNOLLY BOVE LODGE & HUTZ LLP, PO BOX 2207, WILMINGTON, DE, 19899-2207, US

(21) Appl. No.: 12/303,280

(22) PCT Filed: Mar. 9, 2007
(86) PCT No.: PCT/EP07/02059

§ 371 Date: Jan. 13, 2009

(30) Foreign Application Priority Data
Jun. 7, 2006 (DE) 10 2006 026 800.8

(51) Int. Cl. B67D 5/16

(52) U.S. Cl. 222/1; 222/52; 222/63

(57) ABSTRACT

A metering apparatus for flowable preparations includes a metering unit having an energy source, a control unit and a sensor unit. A container for a first flowable preparation, such as a detergent, cleaning agent, or fragrance, is removably couplable to the metering unit. A micropump that has a specific delivery quantity of less than 500 l/min is provided in the metering unit. The micropump can be controlled by the control unit to dispense flowable product from the container into a desired system external to the metering apparatus, such as a dishwasher, washing machine, toilet, air freshening system, and the like.

The invention relates to a metering apparatus for flowable compositions, in particular compositions that contain laundry detergents, cleaning agents, and/or fragrances. The invention further relates to containers for use in the metering apparatus according to the present invention, and to a method for operating the metering apparatus.

### BACKGROUND OF THE INVENTION

Accurate and demand-compatible metering of flowable compositions is relevant for a large number of application sectors.

The metering of flowable substances is becoming increasingly important especially in the household sector, based principally on exact and demand-controlled metering of the corresponding active substances; the result is, on the one hand, to reduce environmental impact by resource reduction and the avoidance of incorrect metering and over-metering, and, on the other hand, to optimize the efficiency of the active substances thus metered.

### Metering of Cleaning Agents in Automatic Dishwashers

Cleaning agents for automatic dishwashers are often used today in the form of dishwashing-agent tablets. Although application and metering are comparatively simple and convenient for the user, active-substance release from the tablets is not optimized in terms of the dishwashing and drying cycles of the respective dishwasher.

Metering apparatuses for dispensing cleaning agents during the dishwashing cycles of an automatic dishwasher are known, for example, from WO 2006/021764. The dispensing of cleaning agents is controlled in this context by a bimetallic element that, when a predetermined temperature is reached, triggers a spring mechanism that causes the release of cleaning agents into the automatic dishwasher.

A substantial disadvantage of this metering apparatus is its complex mechanical construction, with the result that the costs for manufacturing it are high. In addition, the release mechanism can be triggered only by the fact that temperatures in the dishwasher exceed or fall below defined levels. No possibility exists in this context for utilizing different parameters to trigger cleaning-agent release.

In addition, the apparatus known from WO 2006/021764 is not suitable for releasing liquid or gelled preparations. This would, however, be advantageous in particular because higher active-substance concentrations usually can be achieved in liquids or gels than can be achieved in solid dosage forms such as, for example, powders or tablets.

### Metering Laundry Detergents in Washing Machines

Laundry detergents today are usually metered via a metering drawer of the washing machine into the drum filled with laundry. Metering is accomplished by flushing the metering drawer with water, with the result that the laundry detergent is dissolved or entrained, and directed into the laundry drum. The metering drawer can comprise three chambers, one being embodied for reception of a laundry detergent for the pre-wash cycle, one for reception of a laundry detergent for the main washing cycle, and one for reception of a conditioner.

A problem with these metering drawers is that metering of the laundry detergent out of the drawer can be controlled in only limited fashion. Usually the entire quantity of laundry detergent present in the corresponding chamber is introduced into the washing drum immediately at the beginning of a washing cycle, by flushing the metering drawer with water. Exact, time-variant metering of laundry detergent within a washing cycle is thus not possible.

Also known for the metering of laundry detergents are so-called metering balls, which can be filled with a defined quantity of laundry detergent and then placed directly into the washing drum along with the laundry to be cleaned. Here as well, the disadvantage exists that a controlled laundry-detergent release does not occur.

### Metering of Cleaning and Fragrance Compositions in the Toilet Sector

The metering of cleaning and fragrance compositions in the toilet sector is implemented at present principally by way of so-called toilet-bowl dispensers. These are single- or multi-chamber receptacles that are suspended into the toilet bowl in such a way that during the operation of flushing the toilet bowl with water, a discharge of active substance from the toilet-bowl dispenser into the toilet bowl takes place.

Apparatuses of this kind are known, for example, from EP0828902 or DE 10113036.

An essential disadvantage of these toilet-bowl dispensers is that metering depends substantially on the particular local flow conditions in the toilet bowl during the flushing operation. The flow conditions can be very different, however, depending on the type of toilet and the positioning of the toilet-bowl dispenser in or on the toilet bowl. It may happen, for example, that with certain types of toilets no release of active substance from the toilet-bowl dispenser occurs because the toilet-bowl dispenser has no water, or insufficient water, flowing over it during the flushing operation, and the metering mechanism of the toilet-bowl dispenser therefore is not triggered.

Even if a toilet-bowl dispenser has flushing water flowing over it as intended, this is a disadvantage in that a disruption of the water guidance provided by the toilet manufacturer occurs, with the result that the flushing performance of a toilet can be perceptibly reduced.

It would thus be desirable to have available a metering apparatus, for releasing active substances into a toilet bowl, that implements a metering of active substances into the toilet bowl independently of the toilet flushing operation.

It would additionally be desirable if an active-substance release were to occur not only after a flushing actuation. For example, it would be advantageous to meter fragrances or foaming agents into the toilet bowl immediately before the toilet is used, in order to counteract preventively the possible release of unpleasant odorants during use of the toilet.

It is not possible at present to achieve metering in the application instances mentioned above using one metering apparatus, so that at present it is still necessary to use metering apparatuses tailored for the particular application instance.

The above-described metering apparatuses also have large overall volumes in some cases; this is often perceived as disadvantageous for aesthetic reasons and also causes problems in functional terms, since (for example) the usable space in an automatic dishwasher or in a toilet bowl is decreased.

It is furthermore known that many preparations, in particular washing and cleaning preparations, contain surfactants, specifically both anionic and nonionic surfactants, and especially surfactant mixtures, which upon re-dissolution in water tend to form gel phases. With surfactant contents of 15 wt % and above, based on the agent, undesired and dissolution-delaying gelling can already occur upon re-dissolution of the agent in water.

It may happen, in particular as a result of a one-time, surge-like metering as is in most respects usual today with the use of washing or cleaning tablets, that upon the introduction of such surfactant preparations during, for example, a cleaning cycle of a dishwasher, the preparations become covered with gel layers immediately after metering into the dishwasher interior and contact with water, which layers then also prevent rapid dissolution of the preparation enclosed by the gel layer. The greater the metered quantity discharged on a one-time, surge-like basis, and the colder the water in which the preparation is to be dissolved, the more pronounced this effect becomes.

The result of this can be that at the end of the dishwashing program, gelled preparation residues remain behind in the dishwasher or on the dishes, and the release of surfactant during the washing cycle possibly may be insufficient to yield satisfactory cleaning performance by the preparation. These disadvantageous effects in the context of metering of gelling-susceptible surfactant preparations are not limited to the sector of dish cleaning, but are also known in the sectors of textile cleaning and toilet care.

A metering apparatus that releases gelling-susceptible surfactants in such a way that gelling is very largely suppressed, or at least greatly reduced, is therefore desirable.

### OBJECT OF THE INVENTION

It is therefore an object of the invention to prevent the disadvantages of the metering apparatuses of the kind mentioned above, and to make available a metering apparatus that achieves more exact metering of flowable compositions upon the occurrence of defined mechanical, electrical, physical, and/or chemical conditions.

A further object of the invention is to make available a metering apparatus that releases gelling-susceptible surfactant mixtures in such a way that the risk of gelling is at least greatly reduced.

The object is achieved in that a metering apparatus for flowable preparations encompasses a metering device having an energy source, a control unit, and a sensor unit; as well as at least one first container that contains a first preparation and is couplable to the metering device, the metering device encompassing a micropump controllable by the control unit and having a specific delivery volume of less than 500 [l/min].

“Couplable” means in this context that the container can be connected to the metering device in such a way that the interior of the container is connected in communicating fashion to the micropump, and leakage-free withdrawal of preparation from the container is achieved.

Separation of the metering apparatus into a metering device and a container couplable to the metering device, with the result that the metering device can be used flexibly for a wide variety of application instances, is to be seen as a substantial advantage of the invention.

Because the metering apparatus uses no mechanical control elements for product release, the metering apparatus can be miniaturized in such a way that it can be used even in applications in which the size of the metering apparatus is critical, for example in toilet-bowl dispensers or in dishwashers for dispensing cleaning agents.

A control unit, a sensor unit, at least one micropump, and the energy source necessary for operation of the metering apparatus are integrated into the metering device. The metering device preferably is made up of a splash-protected housing that prevents water splashes, which can occur, e.g., when the metering apparatus according to the present invention is used in a toilet bowl or an automatic dishwasher, from penetrating into the interior of the metering device.

In order to ensure operation at elevated temperatures such as those that occur, for example, in individual washing cycles of an automatic dishwasher, the metering apparatus can be shaped from materials that are dimensionally stable up to a temperature of 120° C.

Because the preparations to be metered can have a pH of between 2 and 12, depending on the intended utilization, all the components of the metering apparatus that come into contact with the preparations should exhibit corresponding acid and/or alkali resistance. Said components should furthermore, by way of an appropriate material selection, be as far as possible chemically inert, for example with respect to nonionic surfactants, enzymes, and/or fragrances.

It is particularly advantageous to encapsulate the energy source, the control unit, the sensor unit, and the micropump in such a way that the metering device is substantially water-tight, i.e., the metering device is functional even when entirely surrounded by liquid. Encapsulation materials that can be used are, for example, multi-component epoxy and acrylate encapsulating compounds such as methacrylate esters, urethane methacrylates and cyanoacrylates, or two-component materials having polyurethanes, silicones, epoxy resins.

The metering apparatus according to the present invention can be used, for example, for metering cleaning agents in automatic dishwashers or toilet bowls, laundry detergents in washing machines, or fragrances to improve indoor air.

### Micropump

For purposes of this Application, a “micropump” is a microsystems-engineering fluid energy machine for moving or delivering small quantities of a fluid by converting a mechanical drive output into a flow output.

“Fluids” are understood hereinafter as liquids and gases, as well as mixtures thereof and mixtures of such with solids.

The delivery volume of a micropump according to the present invention is usually between 50 nl and 100 ml per minute, preferably between 250 nl and 30 ml per minute, particularly preferably between 500 nl and 5 ml per minute.

The micropump preferably has an overall volume of less than 5 cm³, particularly preferably less than 3 cm³, especially preferably less than 2 cm³.

The specific delivery volume of a micropump, calculated as the ratio of the delivery volume to the overall volume of a micropump, is usually less than 500 [l/min]. The specific delivery volume is preferably between 1 and 300, particularly preferably between 1.5 and 200, especially preferably between 2 and 150, very particularly preferably between 2.5 and 100 l/min.

This selection of specific delivery volumes allows the metering of, in particular, surfactant-containing preparations with no risk of gelling of the preparations upon release.

The micropump can be selected from the group of the displacement pumps, oscillating pumps, membrane pumps, piston pumps, rotary pumps, dynamic pumps, centrifugal pumps, electrohydrodynamic pumps, electroosmotic pumps, magnetohydrodynamic pumps, surface acoustic wave pumps, capillary force pumps, electrowetting pumps, and/or thermocapillary pumps.

Membrane pumps are particularly advantageous for the metering of laundry detergents and cleaning agents, and of fragrances.

Membrane pumps are usually made up of an inlet valve and an outlet valve, respectively, into and out of a pump chamber that is constituted partly from a pump membrane, and of an actuator.

When the inlet valve is closed, the actuator causes a compression of the pump chamber by mechanical action on the pump membrane, with the result that the fluid present in the pump chamber is delivered out of the pump chamber through the opened outlet valve.

Once the ejection operation is complete, the outlet valve is closed and decompression of the pump chamber is caused by the actuator, with the result that the fluid is drawn into the pump chamber through the (now open) inlet valve.

It is evident that the delivery direction of the micropump can be influenced or reversed by suitable configuration and/or control of the valves and of the actuator.

The actuator of the membrane pump can be selected, for example, from the group of the electric-motor, piezoceramic, bimetallic, memory metallic, pneumatic, peristaltic, electrostatic, electromagnetic, and/or thermal drive units.

The valves can be embodied as active or passive valves. The passive valves can be, in particular, flap valves, membrane valves, or no-moving-parts valves.

Depending on the field of application, pressure-side discharge of the preparation from the metering apparatus can be accomplished dropwise, in stream or spray fashion, diffusively, or by evaporation.

Especially with preparations that tend to form deposits upon extended storage, it may be advantageous to arrange the preparation-containing container on the pressure side of the micropump. In this configuration, only a fluid free of deposit-forming substances is delivered through the micropump. In this case it is particularly advantageous to use air as a fluid.

The fluid is pumped under pressure into the container. The container possesses a pressure equalization valve that, when a defined pressure in the container is exceeded, enables product flow out of the container.

This makes it possible, in particular, to use the metering device for a wide variety of preparations without jeopardizing the functionality of the micropump as a result of possible deposits or reactions between two preparations.

### Control Unit

For purposes of this Application, a “control unit” is an apparatus that is suitable for influencing the transportation of material, energy, or information. For this, the control unit influences converters with the aid of information that it processes for purposes of the control objective.

The converters can be, for example, micropumps and/or valves.

The control unit can be, in particular, a programmable microprocessor. In a particularly preferred embodiment of the invention, a plurality of metering programs, which are selectable and executable in accordance with the container coupled to the metering device, are stored in the microprocessor.

In a preferred embodiment, the control unit has no connection to the household appliance control system that might possibly be present. Accordingly, no data, in particular electrical or electromagnetic signals, are exchanged directly between the control unit and the control system of the household appliance.

For the metering of, in particular, gelling-susceptible preparations, the control unit can be configured in such a way that, on the one hand, metering takes place in a sufficiently short time to ensure a good cleaning result, and, on the other hand, the preparation is not metered so quickly that gelling of the surge of preparation occurs. This can be achieved, for example, by way of a release at intervals, the individual metering intervals being set so that the correspondingly metered quantities completely dissolve during one cleaning cycle.

### Sensor Unit

The sensor unit can encompass one or more active and/or passive sensors for qualitative and/or quantitative sensing of mechanical, electrical, physical, and/or chemical quantities, which are conveyed as control signals to the control unit.

The sensors of the sensor unit can be selected in particular from the group of timers, infrared sensors, brightness sensors, temperature sensors, motion sensors, elongation sensors, rotation speed sensors, proximity sensors, flow sensors, color sensors, gas sensors, vibration sensors, pressure sensors, conductivity sensors, turbidity sensors, acoustic pressure sensors, “lab on a chip” sensors, force sensors, acceleration sensors, tilt sensors, pH sensors, moisture sensors, magnetic field sensors, RFID sensors, magnetic field sensors, Hall sensors, biochips, odor sensors, hydrogen sulfide sensors, and/or MEMS sensors.

In its simplest conceivable embodiment, the sensor unit can be embodied as a tilt switch, pressure switch, or contact switch.

Especially in the context of preparations whose viscosity fluctuates greatly as a function of temperature, it is advantageous to provide flow sensors in the metering apparatus in order to monitor the volume or mass of the metered preparations. Suitable flow sensors can be selected from the group of the diaphragm flow sensors, magnetic induction flow sensors, mass flow measurement using the Coriolis method, vortex counter flow measurement methods, ultrasonic flow measurement methods, suspended-particle flow measurement, annular-piston flow measurement, thermal mass flow measurement, or effective-pressure flow measurement.

It is also conceivable to store in the control unit a temperature-dependent viscosity curve of at least one preparation, metering being adapted by the control unit in accordance with the temperature and thus the viscosity of the preparation.

In a further embodiment of the invention, an apparatus for direct determination of the viscosity of the preparation is provided.

The alternatives set forth above for determining the metered quantity or viscosity of a preparation serve to generate a control signal that is processed by the control unit in order to control a micropump so that substantially constant metering of a preparation is brought about.

### Energy Source

For purposes of this Application, an “energy source” is understood as a metering-apparatus component that is appropriate for making available an energy suitable for autonomous operation of the metering apparatus.

The energy source preferably makes electrical energy available. The energy source can be, for example, a battery, a power supply, solar cells, or the like.

It is particularly advantageous to embody the energy source in exchangeable fashion, for example in the form of a replaceable battery.

### Container

For purposes of this Application, a “container” is understood as a packaging means that is suitable for encasing or retaining flowable preparations, and that is couplable to a metering device for discharge of the preparation.

The volume ratio calculated from the overall volume of the metering device and the volumetric capacity of the container is preferably <1, particularly preferably <0.1, especially preferably <0.05. What is achieved thereby is that for a predetermined total overall volume of the metering device and container, the predominant portion of the overall volume is accounted for by the container and the preparation contained therein.

The container usually has a volumetric capacity of <5000 ml, in particular <1000 ml, preferably <500 ml, particularly preferably <250 ml, very particularly preferably <50 ml.

The invention is particularly suitable for dimensionally stable receptacles, such as cups, tins, cartridges, cassettes, bottles, canisters, cans, boxes, drums, or tubes, but can also be used for flexible receptacles, such as pouches or bags, especially when the latter are used in accordance with the bag-in-bottle principle.

In particular, a container can also encompass multiple chambers that are fillable with compositions different from one another. It also conceivable for a plurality of containers to be arranged into one unit, for example a cassette.

Examples of possible combinations of containers or chambers having the corresponding preparations are summarized by way of example, for several application instances, in the table below:

| Application | Container A | Container B | Container C |
|---|---|---|---|
| Toilet-bowl dispenser | Cleaning agent | Fragrance | |
| | Cleaning agent A | Cleaning agent B | |
| | Cleaning agent A | Cleaning agent B | Fragrance |
| Automatic dishwasher | Cleaning agent | | |
| | Cleaning agent A | Cleaning agent B | |
| | Cleaning agent A | Cleaning agent B | Cleaning agent C |
| Washing machine | Laundry detergent | Conditioner | |
| | Laundry detergent A | Laundry detergent B | |
| | Laundry detergent A | Laundry detergent B | Conditioner |
| Clothes dryer | Fragrance | | |
| Air freshener | Fragrance | | |
| | Fragrance A | Fragrance B | |

In a preferred embodiment of the invention, the container comprises an RFID label that contains at least data regarding the content of the container and that is readable by the sensor unit.

This information can be used to select a metering program stored in the control unit. This makes it possible to ensure that a metering program which is optimal for a specific preparation is always used. Provision can also be made that when an RFID label is not present, or in the context of an RFID having an incorrect or deficient identifier, no metering by the metering apparatus occurs, and instead an optical or acoustic signal is generated which informs the user that a fault exists.

In order to preclude misuse of the containers, the containers can also comprise structural elements that coact with corresponding elements of the metering device in accordance with the lock-and-key principle, so that, for example, only containers of a specific type can be coupled to the metering device. This configuration further makes it possible for data regarding the container coupled to the metering device to be transferred to the control unit, with the result that the metering apparatus can be controlled in a manner coordinated with the content of the container corresponding thereto.

### Preparations

For purposes of this Application, “preparations” are flowable compositions that contain at least one substance from the group of cleaning agents, laundry detergents, and/or fragrances.

The preparations preferably contain surfactants, particularly preferably nonionic surfactants, the weight proportion of the nonionic surfactants in terms of the total preparation being preferably 0.5 to 40 wt %, particularly preferably 1 to 15 wt %, especially preferably 5 to 10 wt %.

### LIST OF ILLUSTRATIONS

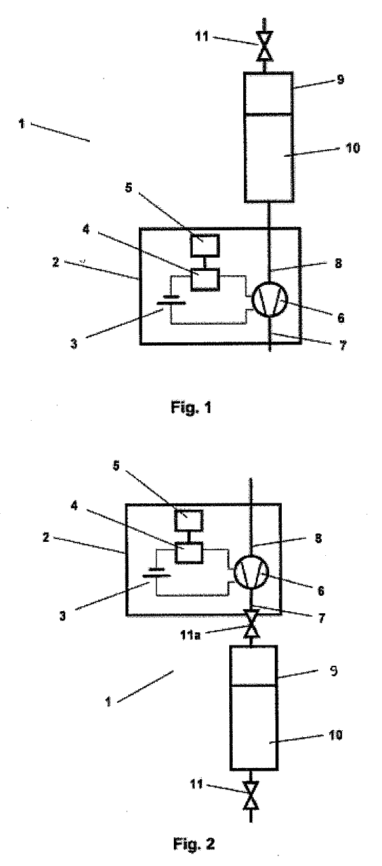

FIG. 1 Metering apparatus having a preparation container on the suction side of the micropump;

FIG. 2 Metering apparatus having a preparation container on the pressure side of the micropump;

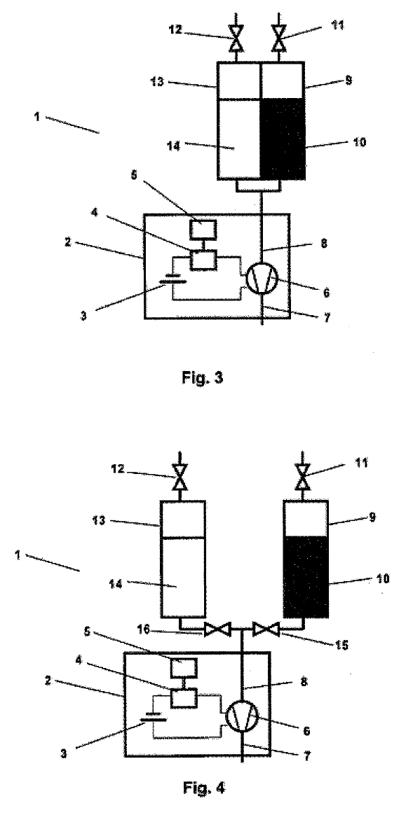

FIG. 3 Metering apparatus having a two-chamber preparation container on the suction side of the micropump;

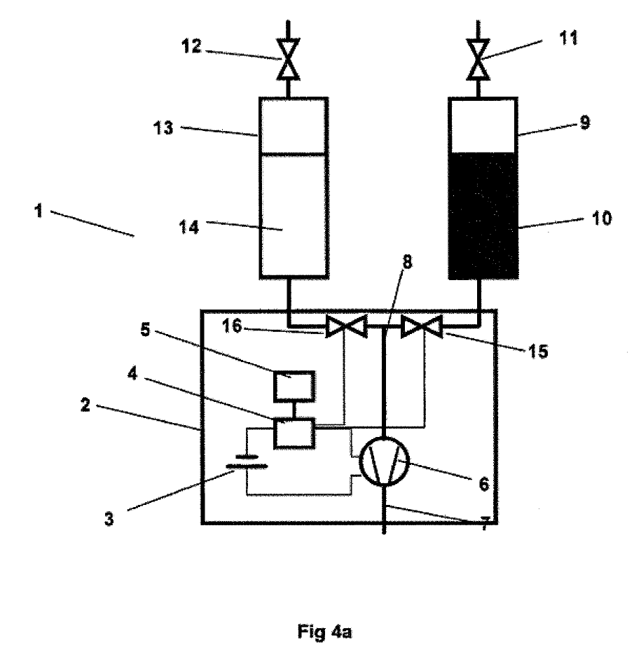

FIG. 4 Metering apparatus having a passively valve-controlled two-chamber preparation container on the suction side of the micropump;

FIG. 4a Metering apparatus having an actively valve-controlled two-chamber preparation container on the suction side of the micropump;

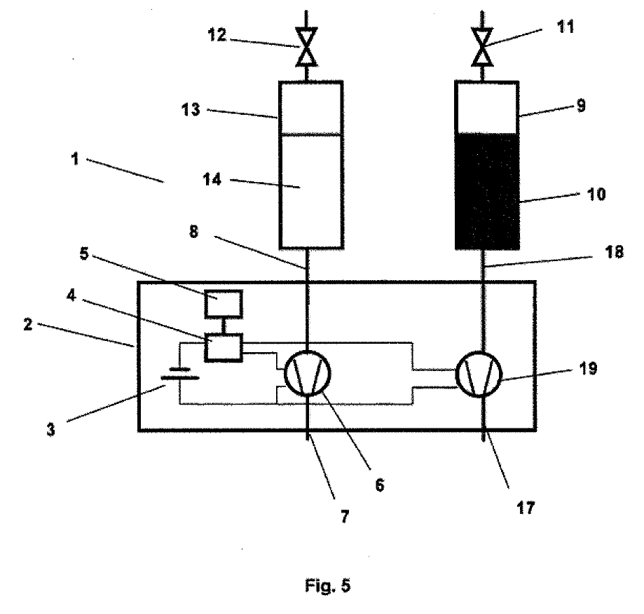

FIG. 5 Metering apparatus having two micropump-connected preparation containers;

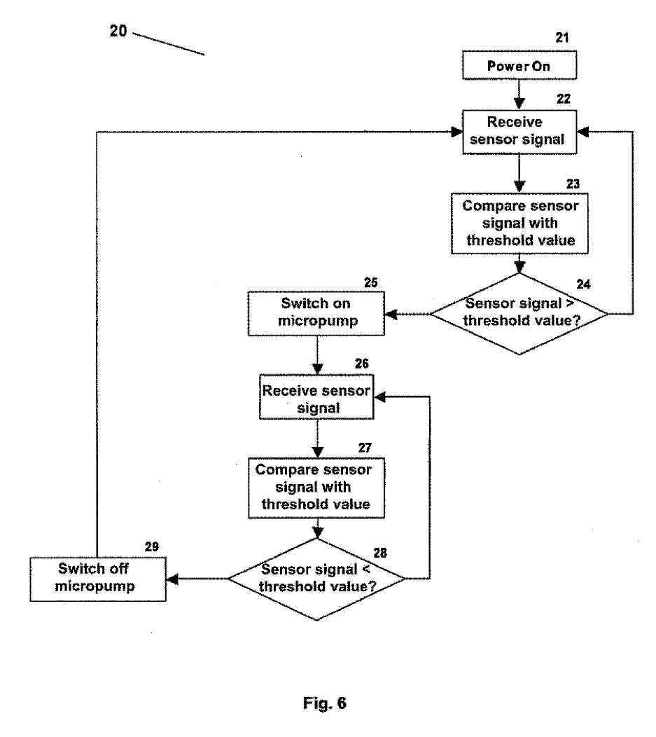

FIG. 6 Flow chart for controlling the metering apparatus having a micropump;

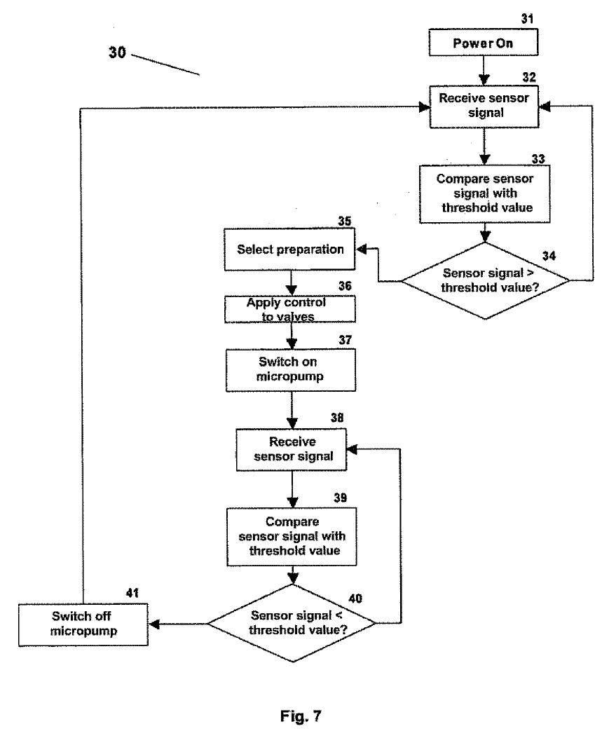

FIG. 7 Flow chart for controlling the metering apparatus having a micropump and multi-chamber preparation container;

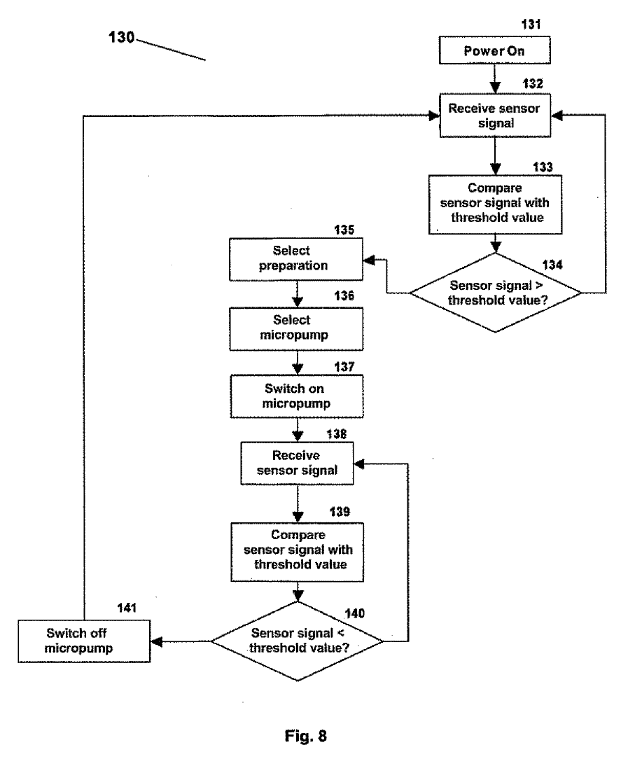

FIG. 8 Flow chart for controlling the metering apparatus having multiple micropumps and multi-chamber preparation containers; and

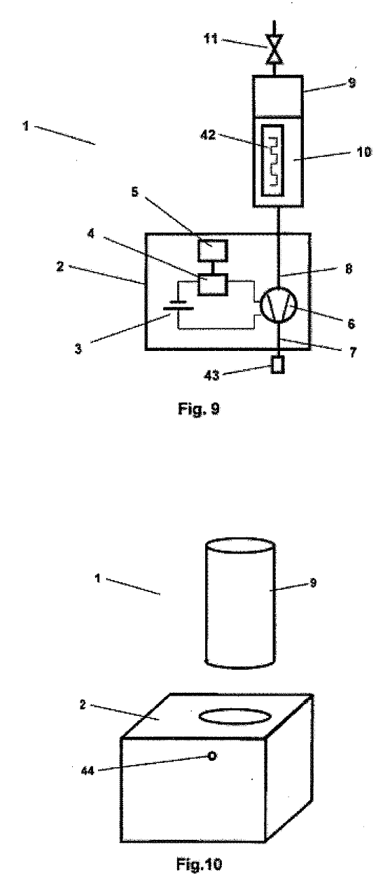

FIG. 9 Metering apparatus having an RFID label on a preparation container.

FIG. 1 shows metering apparatus 1 according to the present invention, which is made up of metering device 2 as well as a container 9 connected to metering device 2 and containing a preparation 10.

Metering device 2 encompasses an energy source 3, a control unit 4, a sensor unit 5, and a micropump 6, these components preferably being integrated in a housing. Micropump 6 is connected via control unit 4 to energy source 3. Control unit 4 is in turn connected to sensor unit 5, which directs control signals to control unit 4 in order to control micropump 6.

Micropump 6 comprises a pressure line 7 and a suction line 8, suction line 8 being connected to container 9 that contains preparation 10. Micropump 6 thus delivers the flowable preparation 10 via suction line 8 out of container 9 into pressure line 7, from which preparation 10 is discharged to the environment of metering apparatus 1. Pressure line 7 can in particular be configured, for example by selection of a suitable diameter, so that it counteracts gelling of the discharged preparation.

Container 9 can comprise a pressure equalization valve 11 that brings about a pressure equalization between the environment and the interior of container 9 when micropump 6 pumps preparation 10 out of container 9.

Micropump 6 can have control applied to it by control unit 4 in such a way that the delivery direction of micropump 6 is reversed, and preparation still present in micropump 6 and in lines 7 and 8 is delivered back into container 9. This backflushing can be advantageous in particular when preparation 10, for example, has a tendency to thicken and thus to clog lines 7 or 8.

FIG. 2 shows a further embodiment of the metering apparatus known from FIG. 1, in which container 9 is connected to micropump 6 on the pressure side. Micropump 6 establishes a pressure in container 9 by pumping ambient air into container 9, so that the preparation is displaced out of container 9. A valve 11 can be provided on the preparation output side of container 9, which valve enables discharge of preparation 10 out of container 9 only when a defined pressure in container 9 is reached. This can be advantageous in particular when what is to occur is not dropwise metering, but instead defined metering in the manner of a spray stream or spray mist.

A nonreturn valve 11a can additionally be arranged pressure line 7 between micropump 6 and container 9 in, which valve prevents the pressure established in container 9 from escaping through pressure line 7 when micropump 6 is stopped.

FIG. 3 shows metering device 2 known from FIG. 1, in which a two-chamber container, constituted by containers 9 and 13, is connected to suction line 8 of micropump 6. Containers 9 and 13 each contain compositions 10 and 14 that differ from one another.

Containers 9 and 13 can each comprise pressure equalization valves 11, 12.

The bottom-side output openings of containers 9 and 13 are connected to suction line 8 and to micropump 6 in such a way that preparations 10 and 14 are pumped through suction line 8 at defined ratios with respect to one another. For this purpose, it may be necessary to configure accordingly the flow conditions in pressure lines 8 leading to the bottom-side output openings of containers 9 and 13.

When more than two different preparations 10 and 14 are used, it is advantageous to control metering in such a way that two mutually compatible preparations are successively delivered in each case through lines 7, 8 and micropump 6.

The incompatibility of two preparations may be based, for example, on an exothermic reaction, thickening, flocculation, change in pH, color shift, or the like.

In addition, a third container can be provided which contains a flushing fluid that clears at least one of preparations 10, 14 out of lines 7, 8 and micropump 6. Air can also be provided for flushing lines 7, 8 and micropump 6. By flushing lines 7, 8 and micropump 6S it is possible to prevent residues of mutually incompatible preparations from coming into contact with one another.

FIG. 4 shows a refinement of metering apparatus 1 known from FIG. 3. In this context, pressure lines 8 leading to the bottom-side output openings of container 9 and 13 each comprise a passive valve 15 and 16, which valves permit a defined setting of the metering ratios of preparations 10 and 14 from containers 9 and 13.

Valves 15 and 16 also can be embodied as temperature-sensitive bimetallic valves that open or close when a defined temperature is reached. In particular, valves 15 and 16 can be selected from bimetallic valves that differ from one another, so that, for example, when a defined temperature is reached only one preparation can be delivered by micropump 6 out of one of containers 9 or 13.

A feature common to the metering devices according to FIGS. 1 to 4 is that by processing the signals from sensor unit 5, control unit 4 regulates only micropump 6.

The principle of control algorithm 20 is reproduced in FIG. 6 in the form of a flow chart.

Control algorithm 20 is activated as soon as metering device 2 is switched on. In a first process step 22, control unit 4 receives the signals of sensor unit 5. In control unit 4, the received sensor signal is compared with a threshold value stored in control unit 4

The next process step 24 checks, on the basis of a selection condition, whether the sensor signal and the threshold value exhibit a defined ratio to one another. If the condition is met, micropump 6 is then activated by process step 25. If the condition is not met, sensor signals continue to be received and evaluated by the control unit in accordance with process step 22.

As is evident from process steps 25 to 29, micropump 6 remains in an activated state until a sensor signal is present that, upon comparison with a threshold value stored in control unit 4, causes the micropump to be switched off. According to this procedure, preparation is pumped out of the container as long as the sensor signal moves between two predefined threshold values for switching micropump 6 on and off.

| Application | Threshold value 1 | Threshold value 2 |
|---|---|---|
| Dishwasher/Washing machine | Temperature | Temperature |
| | Temperature | pH |
| | pH | Temperature |
| | pH | pH |
| | Temperature | Time |
| | pH | Time |
| | Conductivity | Time |
| | Turbidity | Time |

Alternatively, however, it is also conceivable to modify the above-described control system so as to implement a simple trigger circuit, in which an activation of the micropump in accordance with process step 25 brings about discharge of a defined quantity of preparation and then automatically shuts off the micropump, without requiring a further, sensor-signal-based shut-off condition for micropump 6.

As shown in FIG. 4a, it is also possible to embody valves 15 and 16 as components to be controlled actively by control unit 4. The mixing ratio of the two preparations 10 and 14 can thus be influenced actively and in time-variant fashion.

The control system on which this embodiment is based is presented in FIG. 7 with reference to a flow chart 30.

A further possibility for active and time-variant influence on the mixing ratios is shown by FIG. 5. In this embodiment of the invention, each of containers 9 and 13 is coupled to a micropump 6 and 19 to be regulated individually by control unit 4. The corresponding regulation algorithm is reproduced in FIG. 8.

FIG. 9 shows the metering apparatus known from FIG. 1, in which an RFID label 42, which is suitable for identifying the size and content 10 of container 9, is arranged on container 9.

Sensor unit 5 encompasses an RFID receiving unit that can read out the data of RFID label 42 arranged on container 9. These data are conveyed as a control signal to control unit 4 in order to bring about a metering, coordinated with the content of container 9, of preparation 10. In particular, the control signals produced by RFID label 42 can be used to select a metering program stored in the control unit.

It is thereby possible to make available a universal metering device for a plurality of metering applications such as, for example the metering of preparations into automatic dishwashers, washing machines, dryers, toilets, or living spaces.

As an alternative to RFID label 42, the skilled artisan can also provide other means that bring about an automatic identification of container 9 and of its content 10 by the metering device.

An additional discharge apparatus 43 can furthermore be provided at the pressure-side opening of pressure line 7. This discharge apparatus 43 produces a distribution, deviating from dropwise discharge, of the preparation into the environment of metering apparatus 1. This can involve, for example, a stream-like or spray-mist-like discharge of the preparation, or a discharge based on evaporation or diffusion. Discharge apparatus 43 can be embodied for this purpose, for example, as a nozzle, atomizer, distributor plate, or porous surface. In particular, the discharge apparatus can be embodied in such a way that it counteracts gelling of the released preparations.

FIG. 10 is a perspective view of the metering devices known from FIGS. 1 to 5 and FIG. 9. Metering device 2 comprises an interface by means of which receptacle 9 can be coupled to metering device 2. This interface can advantageously, as shown in FIG. 10, be embodied as an opening into which container 9 is introducible. Metering device 2 can comprise an indicator 44 for monitoring function or operating status.

### REFERENCE CHARACTERS

1 Metering apparatus
2 Metering device
3 Energy source
4 Control unit
5 Sensor unit
6 Micropump
7 Pressure line
8 Suction line
9 Container
10 Preparation
11 Pressure equalization valve
11a Non-return valve
12 Pressure equalization valve
13 Container
14 Preparation
15 Valve
16 Valve
17 Pressure line
18 Suction line
19 Micropump
42 RFID label
43 Discharge apparatus (nozzle)
44 Indicator

1. A metering apparatus (1) for flowable preparations, comprising:
a) a metering device (2) having an energy source (3), a control unit (4), a sensor unit (5), and a micropump (6), controllable by the control unit (4), having a specific delivery volume of less than 500 l/min; and
b) at least one first container (9) that contains a first flowable preparation (10) and is couplable to the metering device (2).

2. The metering apparatus according to claim 1, wherein the container (9) is couplable to a pressure side of the micropump (6).

3. The metering apparatus according to claim 1, wherein the container (9) is couplable onto the micropump (6) at a suction side.

4. The metering apparatus according to claim 1, wherein a valve (15, 16) is arranged between the container (9) and the micropump (6).

5. The metering apparatus according to claim 4, wherein the valve (15, 16) is actively controllable by the control unit (4).

6. The metering apparatus according to claim 1, wherein at least one second container (13) for holding a second flowable preparation, is couplable to the metering device (2).

7. The metering apparatus according to claim 6, wherein the discharge of preparations (10, 14) is brought about by the micropump (6) that is couplable to the first container (9), and by a second micropump (19) that is couplable to the second container (13).

8. The metering apparatus according to claim 1, wherein the container (9) has thereon or is marked with an RFID label (42) that contains at least data regarding the content of the container (9) and that are readable by the sensor unit (5).

9. The metering apparatus according to claim 1, wherein the metering device (2) is embodied in at least splash-protected fashion.

10. The metering apparatus according to claim 1, wherein the energy source (3), the control unit (4), the sensor unit (5), and the micropump (7, 19) are encapsulated in such a way that the metering device (2) is water-tight.

11. The metering apparatus according to claim 1, wherein the control unit (4) is a programmable microcontroller.

12. The metering apparatus according to claim 1, wherein a plurality of metering programs are stored on the microcontroller, which programs are selectable and executable in accordance with the container coupled to the metering device.

13. (canceled)

14. (canceled)

15. (canceled)

16. (canceled)

17. A method for controlling a metering apparatus for a flowable preparation, comprising:
a) receiving sensor signals that contain at least data regarding the content of at least one container (9, 13) in which the flowable preparation is contained;
b) comparing the sensor signals with threshold values;
c) generating a control signal when a condition defined by the comparison of the sensor signals with the threshold values is met; and
d) metering the flowable preparation out of the container in response to said control signal with a micropump having a specific delivery volume of less than 500 l/min.

18. A method for controlling the metering apparatus according to claim 13, wherein the condition, defined by the comparison of the sensor signals with the threshold values, for generating a control signal is selected in accordance with the content of at least one container (9, 13).

19. (canceled)

20. The metering apparatus according to claim 1, wherein the flowable preparation is selected from the group consisting of cleaning agents, laundry detergents, dishwashing deterrents, fragrances and conditioners for use in automatic dishwashers, washing machines, toilet bowls, and air freshening units.

21. The method of claim 17, wherein the sensor signals contain data that represent at least one physical, chemical or mechanical parameter of the flowable preparation or of an environment into which the flowable preparation is to be dispensed.

22. A metering system for metering flowable preparations, comprising:
a metering device having an energy source, a control unit, a sensor unit, and a micropump, said micropump being controllable by the control unit and having a specific delivery volume of less than 500 l/min;
at least one first container that contains a first flowable preparation and is couplable to the metering device;
at least one suction passage through which the first flowable preparation flows from the container into the micropump; and
at least one discharge from which the flowable preparation exits the metering device.

23. The metering system according to claim 22, wherein the container has an REID label that contains at least data regarding the content of the container.

24. The metering system according to claim 22, further comprising a pressure equalization valve connected to the container.

25. The metering system according to claim 22, further comprising a back pressure valve connected to the container.
